(19) United States
(12) Patent Application Publication
(10) Pub. No.: US 2007/0052808 A1
(43) Pub. Date: Mar. 8, 2007

(54) Rotatable camera

(76) Inventor: Osmo Schroderus, Sumiainen (FI)

Correspondence Address: HARRINGTON & SMITH, LLP, 4 RESEARCH DRIVE, SHELTON, CT, 06484-6212, US

(21) Appl. No.: 10/575,039

(22) PCT Filed: Nov. 11, 2004
(86) PCT No.: PCT/FI04/50159

§ 371 Date: Apr. 5, 2006

(30) Foreign Application Priority Data
Nov. 14, 2003 (FI) 20035210

(51) Int. Cl. G03B 19/00

(52) U.S. Cl. 348/207.99

(57) ABSTRACT

The invention relates to an electronic device (10), which includes-a case structure (23), -a display component (19) fitted in connection with the case structure, -camera devices that can be oriented, fitted inside the case structure, including an image sensor (12) fitted entirely inside and optics (20.1, 20.2, 20.2′), and-an aperture arrangement (21.1, 21.2) fitted in the case structure, for exposing the image sensor from the outside, and in which the image sensor is arranged to be rotatable to at least two exposure directions (FS, BS), according to which the aperture arrangement (21.1, 21.2) is arranged in the case structure. At least part of the optics (20.2′) is arranged to be rotatable along with the image sensor (12).

The present invention relates to an electronic device, which includes
a case structure,
a display component fitted in connection with the case structure,
camera devices that can be oriented, fitted inside the case structure, including an image sensor fitted entirely inside and optics, and
an aperture arrangement fitted in the case structure, for exposing the image sensor from the outside, and
   in which the image sensor is arranged to be rotatable to at least two exposure directions, at least to the display-component side and to a different side relative to the display component, the aperture arrangement being arranged in the case structure according to the exposure directions. In addition, the invention also relates to a method in an electronic device for controlling camera devices, software means for implementing the method according to the invention, and an image sensor.

Portable electronic devices equipped with camera devices, such as, for example, mobile stations, can be used for still and video imaging, and also for videoconferencing. In a videoconferencing situation, the opposite party is shown on the display of the device. In still and video imaging, the display of the device acts as the viewfinder.

However, a device technology problem is associated with implementing functionalities of this kind. Normally, in order to perform still and video imaging, lens optics and an image sensor must be arranged on the opposite side of the case structure of the device relative to the display component that acts as the viewfinder. On the other hand, in order to arrange a videoconferencing functionality, the lens optics and image sensor must be on the same side of the device as the display component, because in that case the opposite party is shown on the display while the image sensor is used simultaneously to image and transmit the user's own image to the opposite party.

To implement such functionalities, an arrangement of two separate image sensors in the same device, for instance, is known from the prior art. In that case, the lenses oriented in different directions each have a separate image sensor connected to them. However, the doubling of the camera components makes this quite cost-intensive. In addition, the limited size particularly of portable electronic devices makes it a challenge to arrange the two sensors, as there is no excess space in the case structures of the devices.

US patent publication 2003/0109232 discloses a camera-device arrangement, which is installed in the hinge-pin casing between the device's rotating cover and its body. The hinge-pin casing can then be rotated quite freely through as much as 180 degrees.

U.S. Pat. No. 6,535,239 discloses, as another prior art solution, the division of an elongated one-case structure into two parts, with the aid of longitudinal jointing. The camera devices can then be aimed by twisting the case structure. However, such a solution gives the device a rather deformed appearance.

A third solution depicting the prior art is the use of separate attachable camera modules. One such implementation is disclosed in WO publication 97/26744 (Robb). In it, an image sensor that can be turned in different exposure directions is attached to a portable device, as its own camera module. Such an attachable module also gives the device a deformed appearance and makes it difficult to use.

The difficulty of arranging it in present portable devices which have a slim appearance is, however, one significant drawback associated with the solution disclosed in the above Wo publication. Arranging a rotatable image sensor, together with the necessary optics, in a slim device concept is challenging, as the devices may, in certain structural constructions, be of a size that is even of the same order as that of the height/width of the sensor. In addition, the internal spaces of the cases of the devices are extremely cramped. Further, the properties of the optics facing different directions also differ from each other. This too creates a challenge in order to arrange them in connection with the exposure apertures. For example, the optics arrangements required by video-conferencing use and conventional imaging use also create their own challenges to devices with a slim appearance and equipped with a rotatable image sensor.

The present invention is intended to create a new type of electronic device equipped with camera devices and a method for controlling the camera devices of an electronic device. The characteristic features of the device according to the invention are stated in the accompanying claim 1 and those of the method in claim 9. In addition, the invention also relates to software means for implementing the method according to the invention, and an image sensor, the characteristic features of which are stated in the accompanying claims 13 and 14.

The electronic device according to the invention, by means of which a still/video imaging functionality can be implemented, in which the display of the device is used at least as a viewfinder, and also a videoconferencing functionality, in which the display of the device is used at least to show the opposite party, can be implemented using a single rotatable image sensor, in connection with which at least part of the optics is arranged to be rotatable.

The electronic device according to the invention includes a case structure, in connection with which a display component is fitted. Directional camera devices, which include, an image sensor and, surprisingly, also at least part of the optics, which are arranged to rotate, are fitted inside the case structure. The camera devices can be oriented at least to the display-component side and to a side differing from it, to conform with which the case structure includes an aperture arrangement for exposing the image sensor from outside the device. A characteristic feature of the electronic device according to the invention is that, besides the image sensor, at least part of the optics is arranged so that it can be rotated along with the image sensor to at least two exposure directions, the aperture arrangement being arranged in the case structure to conform with the exposure directions.

In the method according to the invention, the image sensor and at least part of the optics are oriented by turning them, relative to the device, to the selected exposure direction, after which imaging can be performed. The method according to the invention is characterized by the image sensor and at least part of the optics required for imaging being oriented by rotating them to the selected exposure direction, without any need to apply any special orienting measures to the actual case structure of the device.

Advantages are gained with the aid of the invention in applications in which, according to the prior art, two image sensors, each with their own associated optics, must be used. In addition, a solution using only a single image sensor can now also be used in mono-block-case devices, in which there is no hinge-pin between the cover and the body. The device according to the invention can be implemented using quite simple mechanical arrangements.

Still/video images can be taken using the rotatable image sensor installed inside the case structure of the device, through an exposure-aperture arrangement oriented to two different sides of the device. At least part of the optics for performing imaging, which, together with the optics arranged rotatably in connection with the image sensor, forms the necessary total optics, is therefore be arranged in connection with at least these two exposure directions. The optics can be arranged in several different ways. They can be partly fixed in connection with the apertures and partly, according to the invention, surprisingly also in connection with the rotatable image sensor. Lens arrangements that are entirely connected to the apertures, or even to the sensor are possible in certain cases.

Further, according to one embodiment, the optics can arranged in an appropriate manner. Thus, the optics connected to the exposure aperture on the display side, for example, can be arranged especially for close-up imaging, as a negotiating party to be imaged during videoconferencing will be generally close to the display of the device, observing the opposite party shown on the display. According to another embodiment, the optics arranged for still/video imaging can be equipped with a focal-length adjustment functionality (zoom).

The use of the invention achieves a particular advantage in the case of devices of a limited case size. The rotation of the image sensor is now also possible in these, even though the internal space of the case might be extremely cramped.

The other features characteristic of the invention will become apparent from the accompanying Claims while additional advantages achieved are itemized in the description portion.

In the following, the invention, which is not restricted to the embodiments disclosed in the following, is described in greater detail, with reference to the accompanying drawings, in which

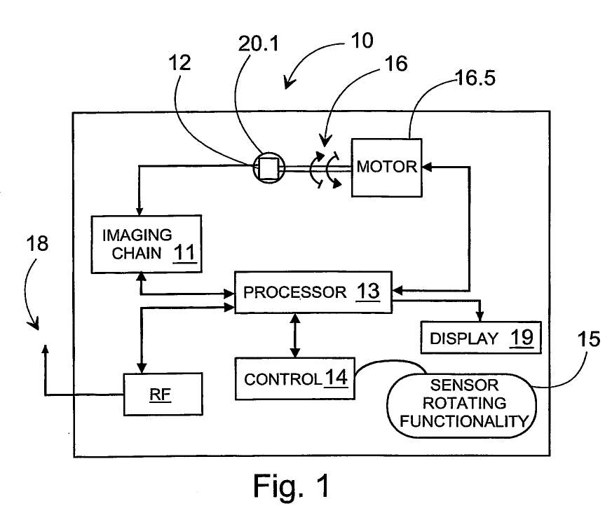

FIG. 1 shows a block diagram of one example of the electronic device according to the invention,

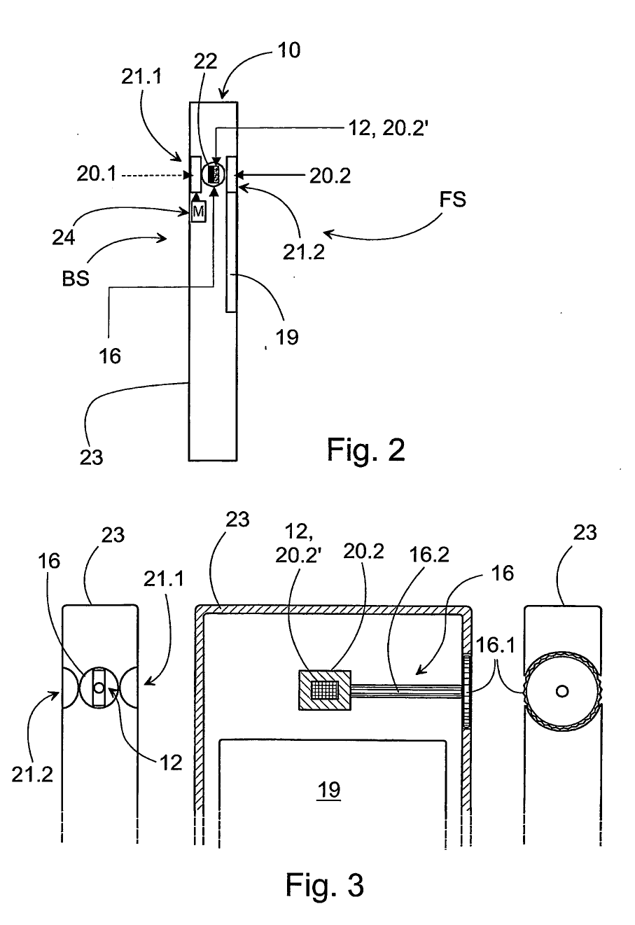

FIG. 2 shows a schematic diagram of the electronic device according to the invention, seen in a cross-sectional side view,

FIG. 3 shows a first embodiment of the electronic device according to the invention,

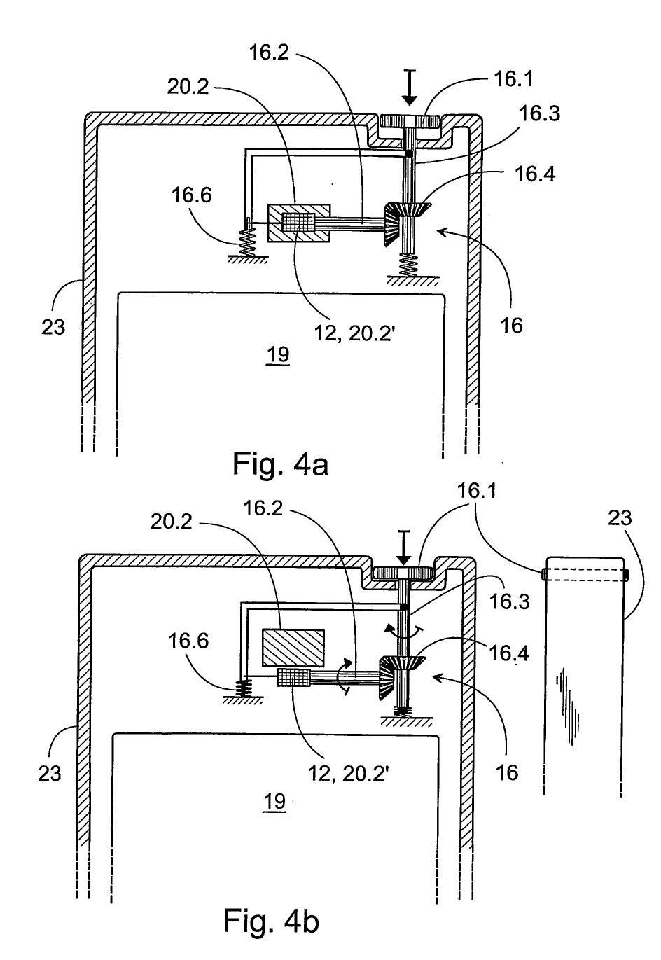

FIGS. 4a and 4b show a second embodiment of the electronic device according to the invention, as a cross-section when the image sensor is being rotated, and

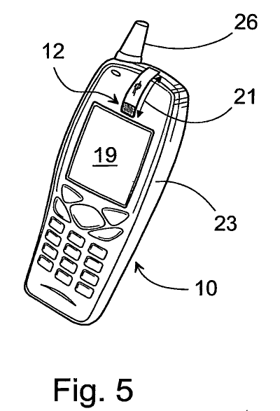

FIG. 5 shows a third embodiment of the electronic device according to the invention.

FIG. 1 shows a rough block diagram of an example of an electronic device 10 according to the invention, which in the following is described in the form of an embodiment in the case of a mobile station. It should be noted that the category of electronic devices, to which the invention and the method according to it can be applied, must be understood as being extremely wide. Some other examples of devices according to the invention are portable and hand-held devices, such as PDA (Personal Digital Assistant) type devices (for example, Palm, Vizor), palm computers, and smart phones. The main feature that the devices according to the invention have in common is that camera devices 12, which for some reason require orienting in order to permit different functionalities, belong to them or can be connected to them in some way.

The mobile station 10 shown in FIG. 1 can be of a type that is, as such, known, so that there is no need to describe in greater detail the components that are not essential to the invention, for instance, the transmitter/receiver component RF. The mobile station 10 includes a digital imaging chain 11, to which camera devices 12, 20.1 that are, as such, known, are 15 connected. The camera devices can include an image sensor 12, which is, as such, of a known type, together with optics 20.1, which produce image information and send it to an image-processing chain 11, which is, as such, of a known type, to be processed to form digital still and/or video image information.

The actual physical totality incorporating the image sensor 12 can be in the device 10 either permanently or detachably. If it is permanent, the image sensor 12 can be inside the actual case structure 23 of the device 10. The case structure 23 of the device 10 can be, for example, a so-called mono-block, when the case 23 is formed from a single unified piece. On the other hand, the case structure 23 can also be of an opening type, such as a ‘clamshell’ (not shown).

One example of a detachable camera device is a camera module that can be connected to the device's connector interface, so that the camera devices can also be disconnected from the actual case structure of the device. In that case, the detachably attachable camera module can also be considered as the case structure of the device.

The functions of the device 10 can be controlled using the processor unit DSP/CPU 13, by which, among other things, the information displayed on the display component 19 of the device 10 can be controlled. The processor unit 13 can be controlled from the user interface 14, which can be understood, for example, as a keypad and various switches.

FIG. 2 shows, as a cross-sectional side view, a schematic diagram of one embodiment of the electronic device 10 according to the invention. The device 10 according to the invention includes a case structure 23, in connection with which there is a display component 19. Inside the case structure 23, there are directional camera devices, which include an image sensor 12 and optics 20.1, 20.2, 20.2′. At least part of the optics can be inside the case 23 and part outside it, for example, if there is a protruding zoom in the device 10.

In the device 10 according to the invention, the camera devices 12 are oriented by rotating the image sensor 12 and also, surprisingly, at least part of the optics 20.2′. When further references are made to rotating/reorienting the sensor 12, the terms will also refer equally to the rotation/reorientation of the optics 20.2′ arranged in the sensor 12. The optics 20.2′ rotating with the image sensor 12 can be in connection with the image sensor 12. In this case, the rotating of the image sensor 12 and at least part of the optics 20.2′ can be understood very broadly, as can be seen in the light of the embodiments presented later.

The case structure 23 also includes an aperture arrangement 21.1, 21.2 for exposing the image sensor 12 from outside. The aperture arrangement 21.1, 21.2 is arranged in such a way that the image sensor 12 can be oriented through them, at least for imaging (for example, in the videoconferencing functionality) performed on the display-component 19 side FS, and for imaging (for example, still/video imaging, in which case the display 19 can be used as the viewfinder) performed on another side BS relative to the display component 19. Generally, these sides are the front side FS and the back side BS, relative to the user of the device 10, depending partly on the shape of the device 10 and on the orienting of the display 19. The angle between the exposure apertures 21.1, 21.2 on the front and back sides FS, BS of the device 10 can then be approximately 180 degrees, though it can also deviate from this, as will be described later.

The paths of rotation of the image sensor 12 and the optics 20.2′ can be arranged in such a way that they can be set in at least two exposure directions FS, BS, in order to select the optical imaging path. The aperture arrangement 21.1, 21.2 associated with the rotation path of the image sensor 12 and the optics 20.2′ is arranged in the case structure 23 according to these exposure directions FS, BS.

In the device 10 according to the invention, the orienting mechanism 16 of the camera devices is operationally in connection with the camera devices, for instance, the image sensor 12. This permits the camera devices and particularly the image sensor 12 and at least part of the optics 20.2′ to be oriented, with no particular rotation measures having to be applied to the actual case structure 23 of the device 10. There is a corresponding aperture arrangement 21.1, 21.2 in the case 23 for exposing the sensor 12 according to the orienting directions FS, BS of the camera devices 12, 20.1, 20.2, 20.2′ in relation to which aperture arrangement 21.1, 21.2 the camera devices, or at least the image sensor 12 and part of the optics 20.2′, are arranged to be oriented, for example, by being rotated relative to an imagined axis of rotation running through the image sensor 12. The axis of rotation can be selected freely.

According to one embodiment, the aperture arrangement can include at least two apertures 21.1, 21.2. In that case, one of the apertures 21.2 can be, for example, on the same side FS as the display component 19, thus permitting the image sensor 12 to be used, for example, in a videoconferencing functionality. The other aperture 21.1 can then be on a different side BS of the case structure 23 relative to the display component 19, in which case the image sensor 12 can be used for still/video imaging while the display component 19 can simultaneously be used as a viewfinder, from which the imaging can be monitored. The image sensor 12 and the display 19 may permit the device to be used for other applications too, for example, to act as a mirror, or a bar-code reader. In mirror operation, image information that is detected through the aperture 21.2 using the image sensor 12 oriented to the display 19 side FS, is shown on the display 19 of the device 10. The embodiment shown in FIG. 5 is better suited to bar-code reader operation.

As is known, the image sensor 12 requires optics to focus the image on the sensor 12. According one embodiment, in the device 10 according to the invention at least one part of the optics 20.1, 20.2 may be connected to the aperture arrangement 21.1, 21.2, for example, as a fixed lens arrangement. In that case, at least another part of the optics 20.2′ can be arranged in a surprising manner in connection with the image sensor 12, so that, if the image sensor 12 is turned, the lens arrangement 20.2′ connected to it will also turn correspondingly with it. On the other hand, the lens groups 20.1, 20.2, 20.2′ can also be either entirely rotatable in connection with the image sensor 12, or entirely fixed in connection with the apertures 21.1, 21.2.

The use of optics 20.2′ that rotate along with the image sensor 12, to which the invention also relates, achieves a particular advantage, for example, in devices with a slim appearance. In such a case, optics 20.1, 20.2 that are fixed only in connection with the exposure apertures 21.1, 21,2 would not necessarily permit the sensor 12 to be rotated from one exposure direction FS, BS to another, instead the optics 20.1, 20.1, for example, or the general internally cramped case structure 23 of the device 10 would limit the path of rotation of the sensor 12.

The optical type/focal length of the optics 20.2′, which is rotatable in connection with the sensor 12, are of such a type that they implement part of the optical system in both imaging directions FS, BS. According to one embodiment, the optics 20.2′ can include a set of microlenses and an infrared filter on the surface of the sensor 12.

According to one, extremely schematic embodiment, the optics 20.2′ arranged rotatably in connection with the sensor 12 can be arranged mainly for close-up imaging, being, for example, a lens/set of micro-lenses 20.2′ with a specific focal length, which possible additional optics 20.1, 20.2 on both sides FS, BS supplements to form an appropriate totality. Thus, optics may not necessarily be required at all in the exposure aperture 21.2 of the display-component 19 side, or it may be very limited, because most of the videoconferencing-side FS optics would already exist in connection with the sensor 12. Correspondingly, the optics 20.1 which is fixed in place in exposure aperture 21.1 on the distant-imaging side BS, will be able to be arranged as being of such a type/focal length that it forms, together with the rotating optics 20.2′ in connection with the sensor 12, an optical arrangement that permits distant imaging. The use of such a choice of optics, which is by way of a very schematic example, will permit part of the optics 20.2′ to be arranged to rotate along with the sensor 12.

According to one embodiment, at least part of the optics 20.1 can be equipped with operating devices 24 for performing, for example, focal-length adjustment operations (zooming/focussing) on the set of lenses 20.1. One example of such an optics is a set of lenses 20.1, arranged in connection with the exposure aperture 21.1 on the opposite side BS of the case structure 23 to the display 19 of the device 10, by means of which distant imaging can also be performed. The optics 20.1 will then include a liner-motion mechanism M for moving it relative to the position of the image sensor 12 and the part of the optics 20.2′ connected to it. The implementation of the zoom mechanism M can apply ways of implementing zoom that are, as such, known, from which sphere extremely small electric motors are presently known. In the case of a zoom implementation, the set of lenses 20.1 may also protrude from the case 23.

The solution according to the invention also permits the use of different optics 20.1, 20.2, 20.2′ in different exposure directions, for example, on the front and back sides FS, BS of the device. According to one embodiment, at least part of the optics 20.2, 20.2′ of the device 10 can be suitably selected, for example, for close-up imaging. According to one embodiment, optics 20.2, 20.2′ of this kind can be, for example, arranged in connection with the exposure aperture 21.2 arranged on the display-component 19 side, because videoconferencing generally takes place in the vicinity of the display 19 of the device 10.

According to yet another embodiment, there can also be shutter devices 22 in connection with the camera devices 12. These can be used to close the exposure aperture 21.1 not in use at the time, to prevent it causing problems with the exposure of the sensor 12 taking place from the desired exposure side FS.

According to one embodiment, the shutter devices 22 can be arranged in connection with the camera devices, for example, on the rear side of the sensor 12. The sensor component 12 can thus be given a spherical shape, in which case there will be a dome-shaped shutter element 22 behind it, for closing the exposure aperture 21.1 that it not in use. This will also facilitate the implementation of the invention in cramped case conditions.

A first rough embodiment of the device 10 according to the invention is shown, in the middle of FIG. 3, as a cross-section seen from the side of the display component 19, with a corresponding cross-sectional side view on the left-hand side of FIG. 3 and a side view of the case 23 of the device on the right-hand side of FIG. 3. In reality, the constructional implementations can, of course, be more sophisticated. In this case, the image sensor 12 and part of the optics 20.2′ are rotated using a rotation wheel 16.1 arranged in connection with the case 23. The wheel 16.1 is suitably set into the case 23 in this case, but can, however, be easily rotated by the user, from its outer circumference. For example, a shaft arrangement 16.2, with a rotatable image sensor 12 and part of the optics 20.2′ according to the invention inside the case 23 at one end of it, can be connected to the wheel 16.1. The arrangement can include a limiter mechanism/clamp, which permits the image sensor 12 and part of the optics 20.2′ to be turned according to the exposure apertures 21.1, 21.2, which in this case are at an angle of approximately 180 degrees to each other. It can also be used to restrict excessive rotation of the sensor 12 and part of the optics 20.2′, which might damage it, for example, by striking the cramped structures inside the device 10. In addition, the orientation of the sensor 12 and part of the optics 20.2′ in the exposure aperture 21.1, 21.2 must be quite precise.

FIGS. 4a and 4b show a second embodiment of the device 10 according to the invention. In this case, the image sensor 12 and the optics 20.2′ can not only be rotated, but also moved in a selected direction. In this case the movement takes place linearly, for example, in the longitudinal direction of the case structure 23. Of course, movement taking place laterally, or in other suitable directions, for example, even in the direction of the exposure apertures 21.1, 21.2, is also possible. Such an arrangement may be required, for example, if the device has a particularly slim case structure 23 and/or the positioning of the components is cramped. The use of the arrangement will achieve an advantage when applying a rotating part of the optics 20.2′ in connection with the sensor 12. When the sensor 12 and part of the optics 20.2′ are in an imaging position between the exposure apertures 21.1, 21.2, it may become impossible to rotate them around their imagined axis of rotation, because the lenses 20.1, 20.2 are so close to each other, due to the thinness of the case 23 and the internal space of the case 23 is otherwise cramped. One example of the possible size of the physical component of the sensor 12 is 10*10 mm, with a thickness of 3-5 mm. The image matrix of the sensor 12 will then have a size of, for example, 3*3 mm.

In FIG. 4a, the image sensor 12 and the optics 20.2′ are next to the exposure apertures 21.1, 21.2 set on opposite sides of the case 23 of the device 10. Using a linear motion mechanism 16, the image sensor 12 and the optics 20.2′ can be moved, for example, in the longitudinal direction of the case 23, so that prior to their rotation from the direction of one exposure aperture to the direction of the other exposure aperture, the sensor 12 and part of the optics 20.2′ are moved out of the space between the lenses 20.1, 20.2 arranged in a fixed connection with the apertures 21.1, 21.2.

In the embodiment shown in FIG. 4a and 4b, the sensor 12 and the lens 20.2′ are moved using a special mechanism 16, which, in this case, must be understood to be only very much in the form of an example. To move the sensor 12 and the lens 20.2′, the case 23 includes a shaft arrangement, with two shafts 16.2, 16.3 at right angles to each other. Between the shafts 16.2, 16.3, there is a bevel-gear arrangement 16.4, for transmitting motion from one shaft to the other. The shaft arrangement 16.2, 16.3 is controlled using a linear motion/rotation switch 16.1 attached to the upper end of the device 10, which permits not only rotational motion, but also linear motion in the longitudinal direction of the case 23. The case 23 may include a recess for this switch 16.1.

When the switch 16.1 is depressed, the sensor 12 and the lens 20.2′ also move correspondingly downwards, thanks to the shaft arrangement 16.2, 16.3. Once the image sensor 12 and the set of lenses 20.2′ connected to it are clear of the position between exposure aperture 21.1, 21.2 and the lenses 20.1, 20.2 associate with them, they can be rotated to a another position, to another desired exposure direction (FIG. 4b). After this, for example, due to spring elements 16.6 belonging to the shaft arrangement 16.2, 16.3, the linear motion mechanism returns the image sensor 12 and the lens 20.2′ to a position between the lenses 20.1, 20.2, or at least connects it with the lens of the desired exposure direction, the sensor 12 together with the lenses 20.2′ then being oriented to the other exposure aperture.

In general, the rotation and/or linear movement of the image sensor 12 and the optics 20.2′ can be performed using rotation elements 16, 16.1 arranged in connection with the device 10, or also using electric-motor devices 16.5 (FIG. 1) which will permit the case structure 23 of the device 10 to be implemented smoothly, without requiring special protruding thumb-wheels. In motor-powered rotation of the sensor 12, control can be implemented, for example, through the user interface GUI of the device 10.

In the embodiment shown in FIGS. 3, 4a, and 4b, the rotation of the image sensor 12 is performed so that it takes place relative to an imagined axis of rotation running through the sensor 12, which is thus rotated through about 180 degrees. FIG. 5 shows a third embodiment, in which the sensor 12 can be rotated from one exposure direction to another, by moving it from one position to another, while still permitting the use of the display 19, as described above. This allows a slide path to be arranged for the sensor 12 and the optics 20.2′ connected to it, for example, in association with the case structure 23, and along which it can be moved, for example, under motor power by a user-interface command.

When the sensor 12 is in the videoconferencing position, it will be on the same side of the device 10 as the display 19, as shown in FIG. 5. If the sensor 12 is moved to its still/video-imaging position, it is moved to the opposite end of the longitudinally arranged exposure aperture 21, so that it takes up a position, for example, at the upper end of the case 23 of the device 10, where, in this case, there is also the antenna 26 of the device 10. The elongated opening 21, of which in this case there is thus only one, can incorporate an elongated shutter element, which is used to prevent light reaching/being reflected to the sensor 12, for example, from areas of the exposure aperture outside the sensor 12. When imaging takes place with such a device 10, the antenna end of its case 23 is oriented to the direction in which it is intended to perform the imaging. Using such ‘pointer’ type image sensor 12 orientation, the progress of the imaging can still be examined using the viewfinder. The embodiment is eminently suitable, for example, for reading bar-codes. In addition, because, thanks to the embodiment, the device 10 does not need to be held in the traditional vertical position in front of the user's view, the embodiment also permits an improved possibility to observe the imaging environment.

On the other hand, the sensor 12 can also be implemented to be rotated around its imagined axis of rotation, in connection with the elongated exposure aperture 21 shown in FIG. 5. In that case, rotating the sensor 12 from the videoconferencing position to the still-imaging position will only need a change of angle of approximately 90 degrees, if, in the still-image position, the sensor 12 points in the longitudinally in the direction of the antenna 26.

With reference to FIG. 5, other design aspects can be taken into account relating to the case structures, the exposure aperture arrangement 21, 21.1, 21.2 and the rotation of the image sensor 12 can be implemented using a large variety of orientation-angle arrangements, which can differ from the 180-degree rotation-angle implementation shown in FIGS. 3, 4a, and 4b.

As already stated, in the case of a camera module that is detachably attached to the connector interface of the device, the rotation of the image sensor can be controlled using commands given to the camera module through the connector interface, in which case the image sensor in the module can be motorized.

In addition to the device 10, the invention also relates to a method for controlling the orienting of camera devices 12 in an electronic device 10. Inside the case structure 23 of the device 10, there are directional camera devices, which include at least an image sensor 12 and optics 20.1, 20.2, 20.2′. The case structure 23 also includes an aperture arrangement 21.1, 21.2, for exposing the image sensor 12 from outside, which is arranged in at least two exposure directions BS, FS.

In the method according to the invention, the image sensor 12 and at least part of the optics 20.2′ are aimed relative to the device 10 by rotating them to the chosen exposure direction, preferably, however, without applying the orienting operations to the actual case structure 23 of the device 10. After this, imaging can be performed. In addition, in the aperture arrangement 21.1, 21.2, the part of the aperture arrangement that is not in use at the time can be closed. It is also possible to move the sensor 12 and at least part of the optics 20.2′ away from connection with the exposure apertures 21.1, 21.2, so that the rotation ability of the camera devices 12, 20.2′ will be improved. This is important, for example, in thin device constructions, the internal spaces of the cases 23 of which are very limited in terms of rotation in place.

In the cases shown in FIGS. 3, 4a, and 4b, in which the image sensor 12 and the lens 20.2′ are rotated from one exposure direction to another around their imagined axis of rotation, the matrix row of the upper part of the sensor 12 in the first exposure direction FS becomes, after rotation, the matrix row of the lower part of the sensor 12 in the second exposure direction. To take this into account, the device can include detection devices 16.5, which can be used to identify the optical imaging path FS, BS that is active at the time. Identification can be performed, for example, from position data obtained from the rotation motor 16.5 in the case of motorized rotation, or in some other suitable manner.

Further, in order to implement the method according to the invention, the device according to the invention can include software means for controlling the aiming of the camera devices. These can be used to orient the image information in an appropriate manner on the basis of the image-path information obtained from the detection devices 16, for example, for display on the display 19, or for transmission to the other party. The software implementation can be, for example, in the processor 13 of the device 10, in the controller component 14 (FIG. 1), and it can also be connected to the rotation functionality 15 of the sensor 12, which can be, for example, the rotation-switch implementation described, a keyed-in command, or a virtual selection alternative in the user interface.

It must be understood that the above description and the related figures are only intended to illustrate the present invention. The invention is thus in no way restricted to only the embodiments disclosed above or stated in the Claims, but many different variations and adaptations of the invention, which are possible within the scope on the inventive idea defined in the accompanying Claims, will be obvious to one versed in the art.

1. An electronic device, which includes
a case structure,
a display component fitted in connection with the case structure,
camera devices that can be oriented, fitted inside the case structure, including an image sensor fitted entirely inside and optics, and
an aperture arrangement including at least two apertures fitted in the case structure, for exposing the image sensor directly from the outside, and
in which the image sensor is arranged to be rotatable to at least two exposure directions (FS, BS), at least to the display-component side (FS) and to an opposite side (BS) relative to the display component, according to which exposure directions (FS, BS) the aperture arrangement is arranged in the case structure and at least part of the optics is arranged to be rotatable along with the image sensor and at least part of the optics is arranged in connection with the aperture arrangement, characterized in that the image sensor and the optics arranged in connection with it can be linearly moved in the case structure, in order to permit their rotation.

2. A device according to claim 1, characterized in that at least part of the optics, is equipped with actuator devices, for example, in order to permit alteration of the focal length.

3. A device according to claim 1, characterized in that at least part of the optics, such as, for example, the optics arranged on the display-component side, is arranged for close-up imaging.

4. A device according to any of claim 1, characterized in that in connection with the aperture arrangement there are shutter devices for closing the aperture that is not in use at the time.

5. A device according to of claim 1, characterized in that the shutter devices are in connection with the camera devices.

6. A device according to claim 1, characterized in that in connection with the camera devices there are detection devices for determining the exposure direction (FS, BS) in use at the time.

7. A method for controlling the orienting of camera devices in an electronic device, in which there are directional camera devices inside the case structure of the device (10), including at least an image sensor and optics, and in which the case structure includes an aperture arrangement including at least two apertures in connection with at least part of the optics is arranged for exposing the image sensor directly from the outside, which aperture arrangement is arranged in at least two exposure directions (FS, BS) at least to the display-component side (FS) and to an opposite side (BS) relative to the display component, and in which method
the image sensor and at least part of the said optics is oriented by rotating them to the selected exposure direction (FS, BS) without directing the orienting operations to the actual case structure of the device and
imaging is performed,
characterized in that, the image sensor and the said part of the optics are linearly moved in the case structure, in order to permit their rotation.

8. A method according to claim 7, characterized in that the part of the aperture arrangement not in use at the time is shut off from the aperture arrangement.

9. A method according to claim 7, characterized in that the rotation of the image sensor and the optics is motorized.

10. An image sensor, which can fitted to an electronic device, which electronic device includes
a case structure,
a display component arranged in connection with the case structure,
camera devices that can be oriented, fitted inside the case structure, including the said entirely internally fitted image sensor and optics, and
an aperture arrangement including at least two apertures fitted in the case structure in connection with which aperture arrangement at least part of the optics is arranged, for exposing the image sensor directly from the outside, and
in which the image sensor is arranged to be rotatable to at least two exposure directions (FS, BS), at least to the display-component side (FS) and to an opposite side (BS) relative to the display component, according to which exposure directions (FS, BS) the aperture arrangement is arranged in the case structure and at least part of the optics is arranged to be rotatable along with the image sensor, characterized in that the image sensor and the optics arranged in connection with it can be linearly moved in the case structure, in order to permit their rotation.
